(19) United States
(12) Patent Application Publication
(10) Pub. No.: US 2022/0188973 A1
(43) Pub. Date: Jun. 16, 2022

(54) SYSTEMS AND METHODS FOR SYNTHETIC AUGMENTATION OF CAMERAS USING NEURAL NETWORKS

(71) Applicant: Augmented Reality Media Corp., Inc., Sacramento, CA (US)

(72) Inventor: Sravan Puttagunta, Sacramento, CA (US)

(21) Appl. No.: 17/551,059

(22) Filed: Dec. 14, 2021

Related U.S. Application Data
(60) Provisional application No. 63/125,136, filed on Dec. 14, 2020.

(51) Int. Cl. G06T 3/40; G06N 3/04; G06T 5/00

(52) U.S. Cl. CPC G06T 3/4038; G06N 3/04; G06T 5/005; G06T 3/4046; G06T 5/002; G06T 3/4007

(57) ABSTRACT

A method of augmenting camera devices with neural networks to control framerate, time synchronization, image stitching and resolution, the method comprising: creating synthetic camera frames by using neural networks to interpolate between actual frame captures; utilizing frame interpolation to align camera images when the frames are misaligned in time, with additional hardware; retroactively processing recorded sensor data to achieve time synchronization from multiple camera sensors; stitching temporally misaligned camera recordings together to create spherical or panoramic images with vision pipelines augmented by neural networks; and enhance images by utilizing neural networks to adjust optimize resolution.

This application claims priority under 35 USC § 119(e) to U.S. Provisional Application No. 63/125,136, filed on Dec. 14, 2020, the contents of which is hereby incorporated by reference in its entirety.

### BACKGROUND

### Field

Methods and apparatus for enhancing camera performance using Neural Networks are provided. More specifically, cameras may leverage an synthetic artificial intelligence (AI) pipeline to improve frame rate, resolution, high dynamic range, removal of image artifacts with image inpainting, and filters for privacy. Neural Networks may also leverage orthogonal sensors to conduct hypothesis testing. Optimized cross-dimensional sensor platforms may assist Neural Networks to enhance accuracy. Deployment of synthetic AI pipeline using Neural Networks may be executed in the cloud, on-device, or on-chip with dedicated hardware.

### Related Art

Related art performant cameras are bulky, cost-prohibitive, unnecessarily complex, and have limitations in bandwidth, resolution and high latency, due to serialization. These limitations of the related art cameras restrict the capabilities of the camera, and further negatively impact the performance of AI pipelines with respect to the camera data.

### SUMMARY

Aspects of example implementations are directed to process to leverage Neural Networks to enhance camera performance synthetically. By augmenting the raw camera feed with a synthetic camera feed generated using Neural Networks, matching of the performance of state-of-the-art machine vision cameras can be performed with commodity (e.g., inexpensive) camera sensors. In addition to performance benefits, this disclosure also leverages Neural Networks to create privacy enabled data captures from camera sensors.

Aspects may include a method of augmenting camera devices with neural networks to control framerate, time synchronization, image stitching and resolution, the method comprising creating synthetic camera frames by using neural networks to interpolate between actual frame captures; utilizing frame interpolation to align camera images when the frames are misaligned in time, with additional hardware; retroactively processing recorded sensor data to achieve time synchronization from multiple camera sensors; stitching temporally misaligned camera recordings together to create spherical or panoramic images with vision pipelines augmented by neural networks; and enhance images by utilizing neural networks to adjust optimize resolution.

Further aspects may include a method to transfer image data on bandwidth constrained communication channels, the method comprising downscaling images and transferring the downscaled images over a communication channel using neural networks; upscaling using generative networks to restore the original image from a downscaled image; utilizing hardware encoders and decoders to process images using neural networks; interleaving large images with small images and using neural networks to upscale the smaller images to match the resolution of larger images; and creating a mosaic of images by finding overlapping sections of imagery and sampling pixels from multiple images to achieve a higher resolution using neural networks.

Still further aspects may include a method of removing personally identifiable information from camera video feed using hardware accelerated neural networks, the method comprising blurring and obfuscating personally identifiable information including faces, gait, and unique signatures; blurring and obfuscating vehicular data including license plates, VIN numbers and personnel driving or operating vehicles within camera data; and before exposing the image data to a computing device, ensuring privacy compliance at a sensor level instead of an application layer.

Yet further aspects may include a method of improving or denoising camera data using hardware accelerated neural networks, the method comprising inpainting pixel data using neural networks to remove artifacts including rain, dust, glare, and adverse effects; optimizing image quality in low light conditions by using neural networks to optimize the contrast and clarity within images; and inferring sections of the image which are occluded by objects using generative networks.

### BRIEF DESCRIPTION OF THE DRAWINGS

FIG. 1 illustrates a flow chart of an example embodiment depicting the information hierarchy between a camera and a separate host computer.

FIG. 2 illustrates a flow chart of an example embodiment depicting the information hierarchy between a camera and host computer on a single board computer.

FIG. 3 illustrates the submodules of an embodiment that are utilized for the video pipeline.

FIG. 4 illustrates a state machine that shows the data structures for each state in the flowchart.

FIG. 5 illustrates the different components of the system.

FIG. 6 illustrates a camera 600 according to the example implementations.

FIG. 7 illustrates a carrier board according to the example implementations.

FIG. 8 illustrates cable extension PCBs according to the example implementations.

FIG. 9 illustrates a microHDMl cable connector according to the example implementations.

FIG. 10 shows an insertion scheme according to the example implementations.

FIG. 11 shows an image.

FIG. 12 shows a few example pipelines according to the example implementations.

FIG. 13 illustrates an experiment to compute delta time according to the example implementations.

FIG. 14 illustrates an example according to the example implementations.

FIG. 15 illustrates the prior frame, the next frame, and the synthetically generated frame according to the example implementations.

FIG. 16 illustrates the image according to the example implementations.

FIG. 17 illustrates bi-linear interpolation and an inter area interpolation according to the example implementations.

FIG. 18 illustrates a comparison chart according to the example implementations.

FIG. 19 illustrates a comparison of the zoomed in image quality according to the example implementations.

FIG. 20 illustrates an image according to the example implementations.

FIG. 21 shows a schematic view of the example implementations.

FIG. 22 illustrates a method of augmenting camera devices with neural networks to control framerate, time synchronization, image stitching and resolution.

FIG. 23 illustrates a method to transfer image data on bandwidth constrained communication channels according to the example implementations..

FIG. 24 illustrates a method of removing personally identifiable information from camera video feed using hardware accelerated neural networks according to the example implementations.

FIG. 25 illustrates a method of improving or denoising camera data using hardware accelerated neural networks according to the example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

A method and apparatus is described by which cameras may synthetically enhance their capabilities to boost frame rate, boost resolution, remove artifacts using image inpainting, overlay filters to address privacy concerns and in general provide an abstracted containerized environment to alter/enhance the output of cameras. A synthetic pipeline is provided which leverages Neural Networks to boost camera performance by altering the camera frame buffers with respect to frame rate, resolution, removal of noise/artifacts, and addition/omission of information in the camera frame buffer.

### EXAMPLE COMPUTING ENVIRONMENTS

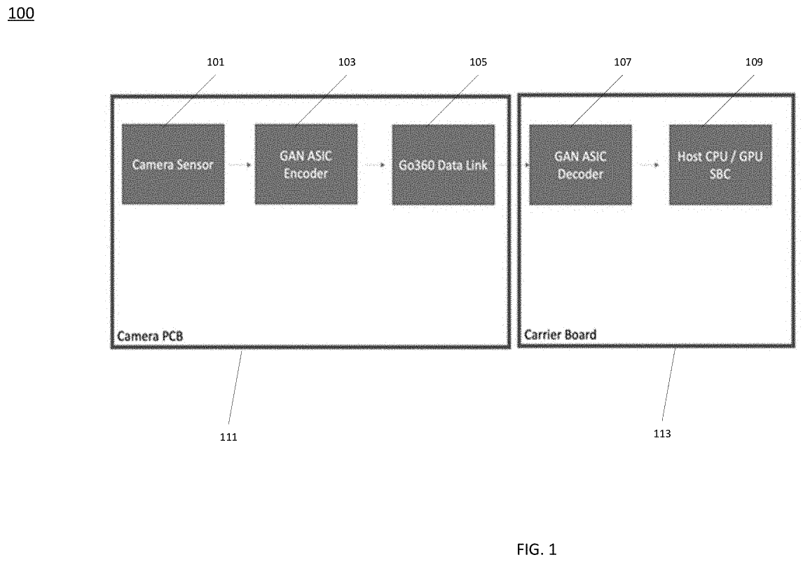

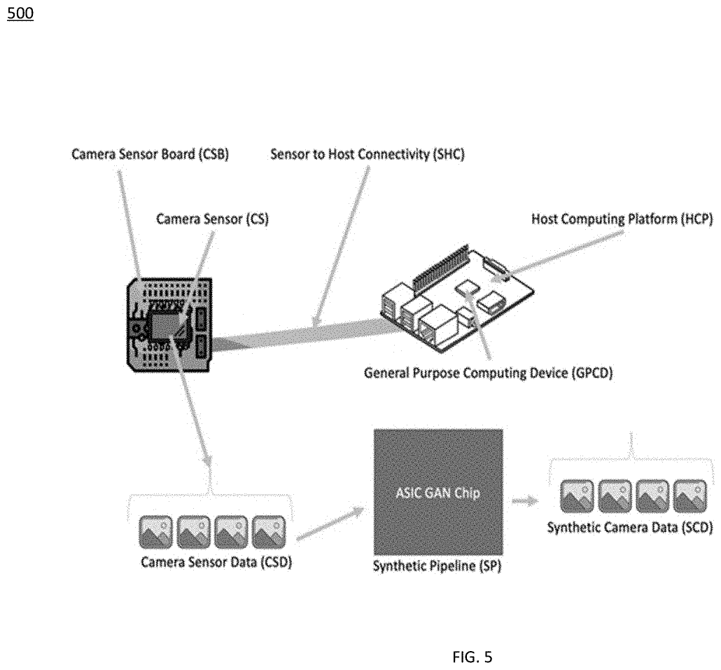

In some embodiments, as shown the schematic diagram 500 in FIG. 5 for example, a printed circuit board with a camera sensor (CS) may rely on an on-board application specific integrated circuit (ASIC) or field programmable gate array (FPGA) or a general purpose computing device (GPCD) hereby described as Sensor Board Computing Platform (SBCP) to enhance the CS output prior to the camera sensor data (CSD) being transmitted from the camera sensor board (CSB). A CSB may use different types of interfaces to transmit CSD from the CS to the central processing unit (CPU) or graphics processing unit (GPU), including but not limited to CSI, CSI-2, MIPI, HD-SDI, USB, Ethernet, WiFi, GMSL, and FPD-LINK III hereby described as Sensor to Host Connectivity (SHC). Furthermore, a CSB may also receive input signals from an external source which can actuate various functions in the Synthetic Pipeline (SP). For example, FIG. 1 illustrates a configuration 100 including a camera PCB 111 that has a camera sensor 101, a GAN ASIC encoder 103, and a data link 105. A carrier board 113 includes an ASIC decoder 107 and a host processor 109.

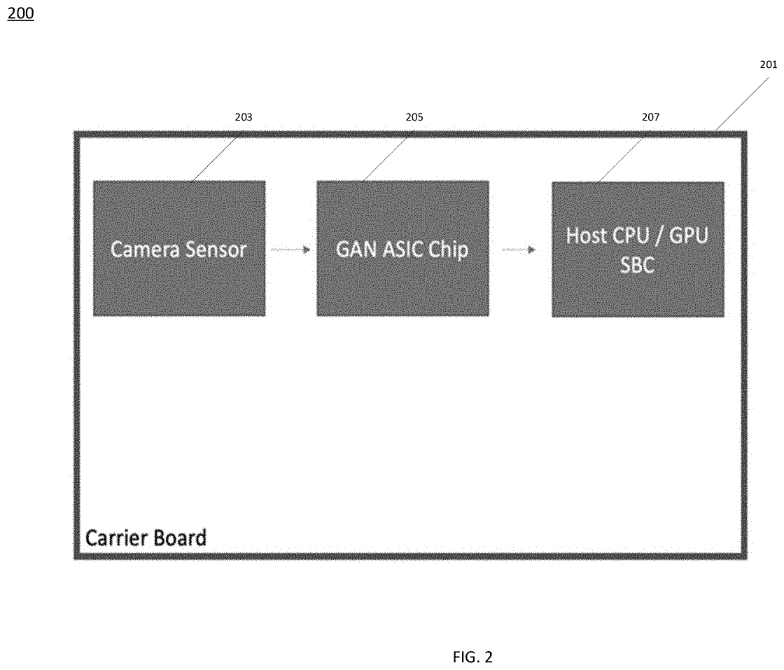

In some embodiments, a CSB may use on-board computing resources made available from the SBCP to synthetically alter the CSD prior to transmission on SHC. For example, as shown in the configuration 200 of FIG. 2, the carrier board 201 may include a camera sensor 203, a GAN ASIC chip 205 and a host processor 207.

In some embodiments, a CSB may directly send its CSD on SHC prior to any alteration and synthetically alter the CSD when a Host Computing Platform (HCP) receives the data on the CPU or GPU computing resources. The HCP may leverage the memory or computing resources available to the CPU and GPU in order to synthetically alter the CSD.

In some embodiments, a CSB may synthetically alter its CSD by Synthetic Frame Generation (SFG). SFG may leverage the temporal, spatial, depth information and a semantic segmentation of the scene to understand how objects of interest are moving through time and space. The temporal and spatial projections of objects may allow the SBCP or HCP to estimate the whereabouts of objects of interest within a scene between frame buffers that are being generated in the CSD. The SFG pipeline may leverage the scene understanding and provide a Neural Network with information the prior frame buffer (PFB), next frame buffer (NFB), an object list along with their telemetry data and a timestamp. The Neural Network may leverage the information with respect to the PFG and NFG to synthetically generate a synthetic frame buffer (SFB) which renders a realist synthetic estimation of the scene. A CSB may leverage this process to synthetically increase or decrease frame rates with arbitrary timestamps within a given range of time, even if the CSD does not contain frame buffers which align with the arbitrary timestamps. This computing process may be executed on the SBCP or the HCP.

In some embodiments, a CSB may receive an object list or raw depth data in the form of a point cloud from an external source. The CSB may elect to choose the object list information from the external source over utilizing the depth data from its own internal estimation. In some embodiments, time of flight sensors such as LiDAR and RADAR may be leveraged to provide higher accuracy, higher frequency and higher resolution depth information to create a more precise scene understanding. In some embodiments, other CSB devices which may obtain a better field of view, better resolution image capture, higher frequency or perspective may be leveraged to estimate the state of the objects of interest within the scene. This computing process may be executed on the SBCP or the HCP.

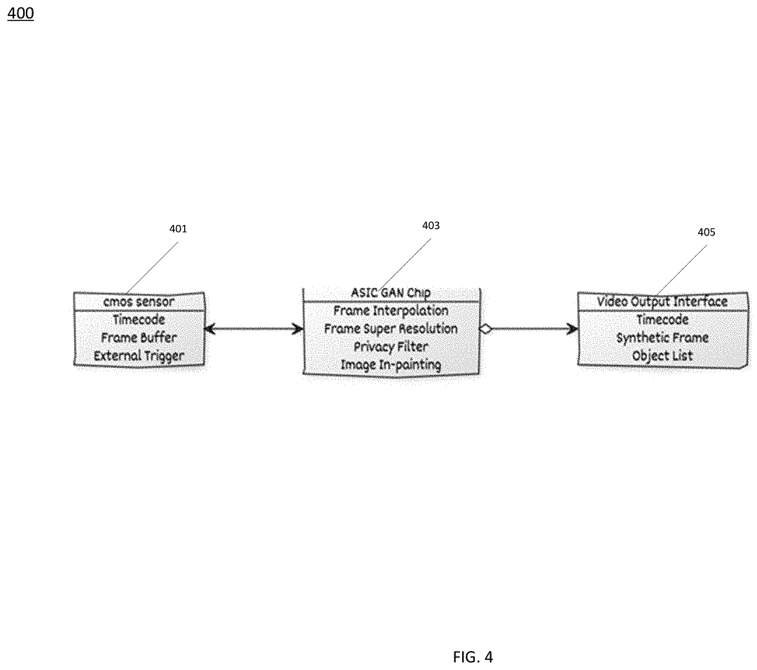

In some embodiments, a set of CSs on multiple CSBs may generate their own independent CSDs without frame level alignment in timing; the SBCP or HCPs may process queries with specific timestamps to synthetically generate SFBs to align the independent CSDs. A set of CSBs may achieve high frames per second frame synchronization even if there is no external trigger actuating the camera shutter in each CSB and even if the CS is unable to produce frame buffers at a high rate by aligning the timestamps of the SFB queries sent to the SBCP or HCP. The SBCP or HCP may leverage encoders/decoders to increase or reduce the frame rate. This computing process may be executed on the SBCP or the HCP. For example, FIG. 4 illustrates a schematic diagram 400 of CMOS sensor 401 (including the timecode, frame buffer and external trigger) coupled to the ASIC GAN chip (performing frame interpolation, frame super resolution, privacy filtering and image-painting), which is in turn coupled to the video output interface 405 (including the timecode, synthetic frame and object list).

In some embodiments, a CSB device may generate CSD that may be synthetically altered to enhance its resolution using Neural Networks. A CSB device may leverage the SBCP or HCP to increase the resolution of the frame buffers in the CSD. A generative adversarial network may be used to optimize the loss function to generate more photo realistic SFBs. The SBCP or HCP may leverage resolution encoders/decoders to increase or reduce the resolution. This computing process may be executed on the SBCP or the HCP.

In some embodiments, a CSB device may generate CSD that may be synthetically altered to generate SFBs with high dynamic range using the SBCP or HCP. A CSB device may leverage a high dynamic range to capture more information in low lumen environments. Low lumen environments may lead to low information at the sensor capture stage. Enhancing the high dynamic range using Neural Networks, may increase the brightness and contrast in the image. A CSB device may leverage a lumen sensor to detect in real-time the current light conditions and automatically configure the inputs provided to the Neural Network to change the dynamic range in the SFB. A CSB device may rely on this functionality when the ambient light transitions quickly from light to dark or vice versa. This computing process may be executed be executed on the SBCP or the HCP.

In some embodiments, a CSB device may synthetically alter the contents of its CSD to leverage Neural Networks to utilize image inpainting to remove unwanted artifacts. The artifacts are not restricted to but may include rain, fog, snow, dust, cracks in the lens, unwanted distortion, sun flares, shadows. This computing process may be executed on the SBCP or the HCP.

In some embodiments, a CSB device may synthetically alter the contents of its CSD to omit any privately identifiable information. A CSB device is not restricted to but may be configured to blur the faces or the complete pedestrians, blurring of license plates from vehicles to omit any privately identifiable information. A CSB device is not restricted to but may be configured to leverage image inpainting techniques to leverage the semantic segmentation of the scene, the object list and object telemetry data to infill and completely remove objects from the scene. This computing process may be executed on the SBCP or the HCP.

SBCP or HCP in computing environment can include one or more processing units, cores, or processors, memory (e.g., RAM, ROM, and/or the like), internal storage (e.g., magnetic, optical, solid state storage, and/or organic), and/or I/O interface, any of which can be coupled on a communication mechanism or bus for communicating information or embedded in the computing device.

SBCP or the HCP device can be communicatively coupled to input/interface and output device/interface. Either one or both of input/interface and output device/interface can be a wired or wireless interface and can be detachable. Input/interface may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Examples of SBCP or HCP may include, but are not limited to, highly mobile devices (e.g., smartphones, devices in vehicles and other machines, devices carried by humans and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

SBCP or HCP can be communicatively coupled (e.g., via I/O interface) to external storage and network for communicating with any number of networked components, devices, and systems, including one or more computing devices of the same or different configuration. Computing device or any connected computing device can be functioning as, providing services of, or referred to as a server, client, thin server, general machine, special-purpose machine, or another label.

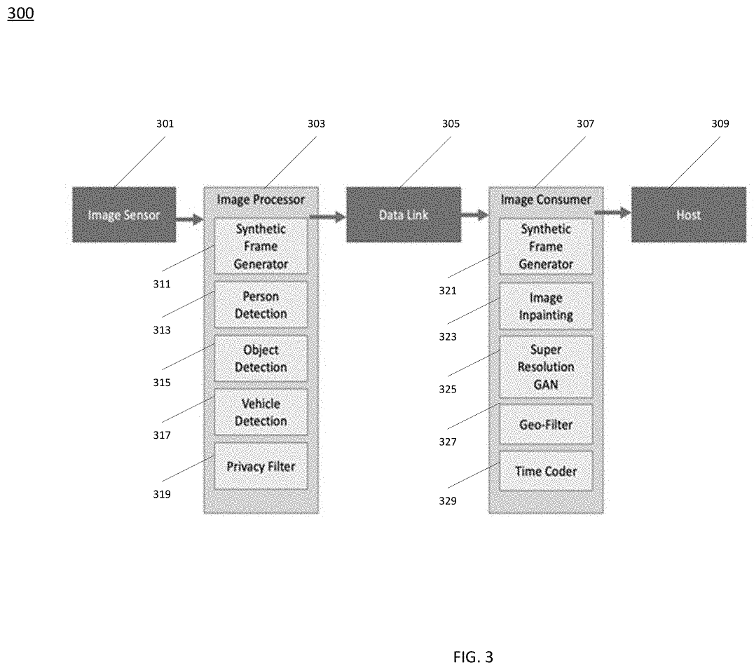

For example, FIG. 3 illustrates a configuration 300 that includes an image sensor 301, an image processor 303, a data link 305, an image consumer 307 and a host 309. The image processor 303 includes a synthetic frame generator 311, a person detection module 313, an object detection module 315, a vehicle detection module 317, and a privacy filter 319. The image consumer 307 includes a synthetic frame generator 321, an image inpainting module 323, a super resolution GAN 325, a geo-filter 327 and a time coder 329.

I/O interface can include, but is not limited to, wired and/or wireless interfaces using any communication or I/O protocols or standards (e.g., Ethernet, 802.11xs, Universal System Bus, WiMAX, modem, a cellular network protocol, and the like) for communicating information to and/or from at least all the connected components, devices, and network in computing environment. Network can be any network or combination of networks (e.g., the Internet, local area network, wide area network, a telephonic network, a cellular network, satellite network, and the like).

Computing device can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) can execute under any operating system (OS) (not shown), in a native or virtual environment. One or more applications can be deployed that include logic unit, application programming interface (API) unit, input unit, output unit.

### SYNTHETIC GAN PIPELINES TO AUGMENT CAMERA PERFORMANCE

As noted above, related art performant, real-time cameras are hard to manufacture and use in real time applications. Specialized machine vision or surveillance cameras are too bulky, cost prohibitive and have too many tradeoffs.

A new scalable performant camera system is small, compact, power efficient, supports high bandwidth capture and low bandwidth transfer requirements. An approach leverages generative adversarial networks to synthetically augmented the physical limitations of commodity rolling shutter cameras to achieve frame level time synchronization, higher framerates and higher resolution. Using a combination of custom PCB hardware, smarter protocols and embedded computing, a real-time low latency high-resolution imaging solution is created that is powerful yet compact with low power utilization.

### Feasibility Study of Synthetic Time Synchronization

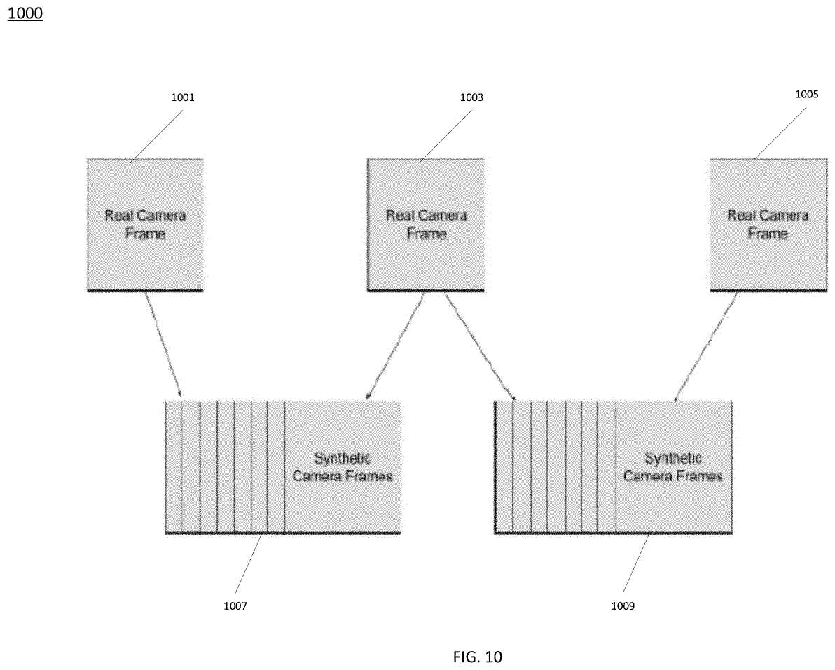

To determine if it is possible to frame synchronize two cameras without an external trigger, it is necessary to first validate a methodology for measuring the time difference between camera frames. Both cameras have access to the system clock on the host machine. According to a method, a computer monitor operates at 60 Hz to render a millisecond clock and created a multi-queue pipeline to timestamp the first frame with a nanoseconds since Epoch offset and a time counter for calculating the time offset since the first frame. For example, this is shown in FIG. 10, which shows an insertion scheme 1000 in which real camera frames 1001, 1003, 1005 are provided, which synthetic camera frames 1007, 1009 interposed in between, using the approach described herein.

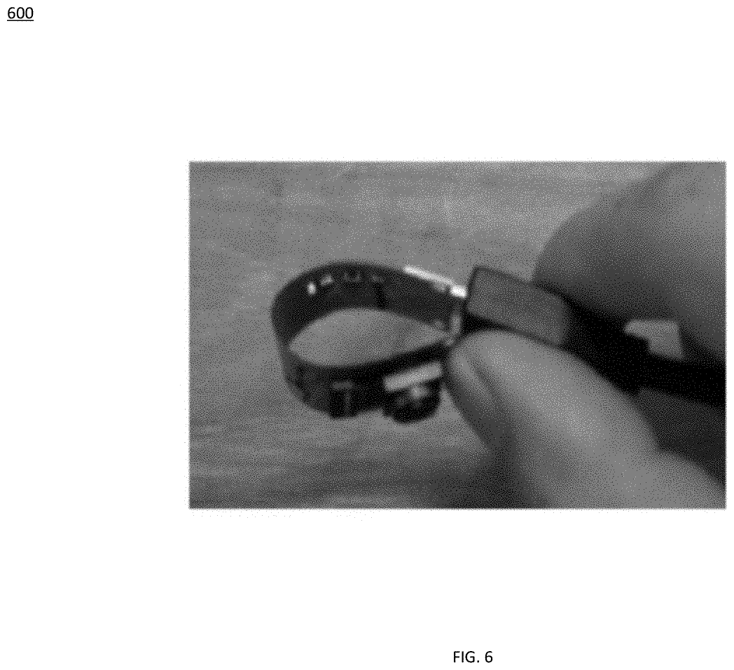

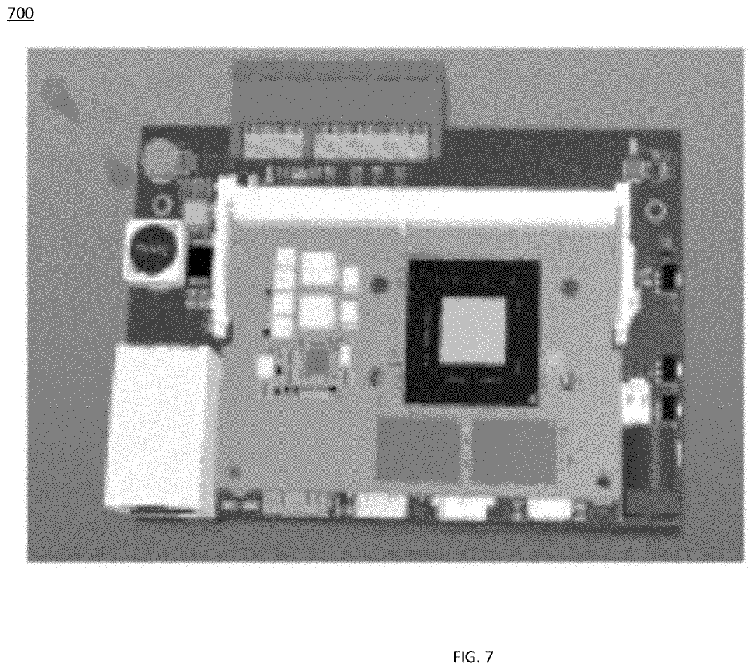

By combining the time stamp from the first frame and adding the time offset, the timestamp of the current frame can be computed. This methodology works if there is no encoding/decoding overhead between the camera and the operating system receiving the frame buffer. Typically, this is viable by directly using the CSI interface on a Xavier NX carrier board 700 as shown in FIG. 7. A camera 600 as shown in FIG. 6, such as the Sony IMX 219 camera, may be used.

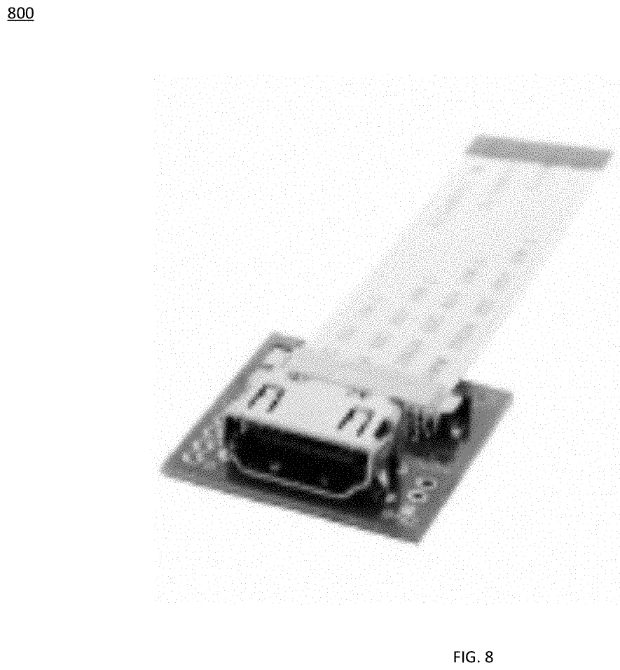

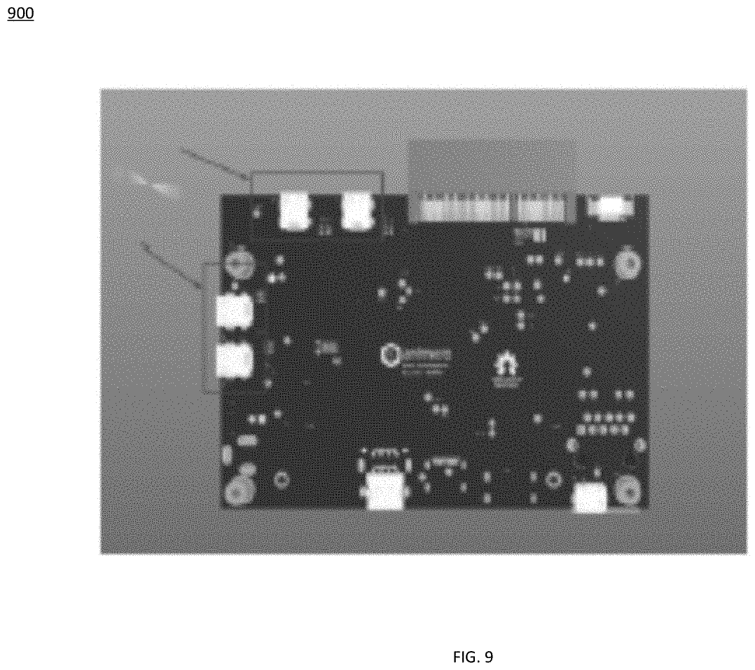

However, most MIPI connectors use ribbon cables that lose signal quality after 30 centimeters. This is a physical limitation that might not be suitable for all applications, especially automotive. By incorporating cable extension PCBs 800 as shown in FIG. 8, a custom Sony IMX 219 PCB board may be used to route the MIPI traces to a microHDMO cable connector 900 instead as shown in FIG. 9. This enables us to use the insulated microHDMI Cat 6 cable that is rated to carry the signal up to 45 feet without compromising signal quality.

The reason this is relevant is it is not necessary to introduce any unnecessary encoding or decoding in the video pipeline. Most USB cameras are rated limited to 5-10 Gbps and the USB bandwidth is shared across multiple ports on the bus. This limits the ability of the host device to capture data from multiple camera devices. Gigabit Ethernet cameras also do not fare well, since they need to process and transfer the raw frame buffer using RTP and H264 encoding and the bitrate is restricted to 1 Gbps. The bandwidth limitation and passing the frames using a video container and codec creates unpredictable latency. In comparison, using the microHDMI cable while retaining the CSI protocols allows the camera sensor to be placed up to 45 feet away but retain the raw uncompressed signal and bypass any unnecessary encoding or decoding. This enables the camera to deliver the frame buffer information from the time the shutter opens to the operating system within 5 milliseconds.

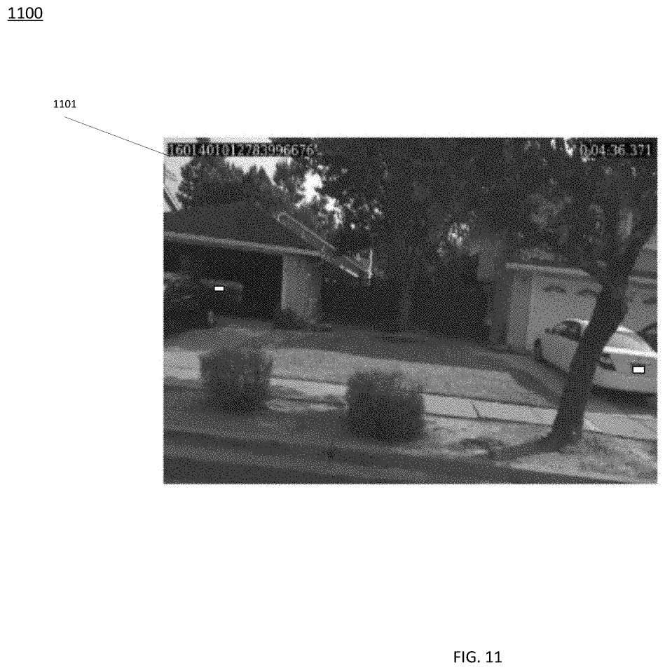

The multi-queue pipeline according to the camera of the present implementation uses the host's video driver, enabling the GPU to directly capture the frame buffer from the CMOS sensor and store it in the GPU memory. This implementation avoids unnecessary context switching between the CPU, RAM, and the GPU; once the frame buffer is in GPU memory, a simple memcopy is executed to grab the frame from the GPU and timestamp it with the system clock as shown in the image 1100 shown in FIG. 11, at the top left, depicted as 1101.

After the starting time is obtained, each frame is also saved with an offset timer on the top right of the frame. By combining the video pipeline starting time with the frame timer, it is possible to obtain the UTC timestamp of the current frame with millisecond precision. Since the pipeline does not actively do any encoding and decoding to other codecs, the sink parameter is specified to use shared memory to route the raw frame buffer. This allows us to create a publish, subscriber model with a one to many mapping using multi-stage video pipelines. Effectively, a second stage video pipeline can also grab the frame buffer from the shared memory buffer and process it in real time or encode various codecs like H264 or MPEG2 for the purposes of network transfer or saving the file to disk.

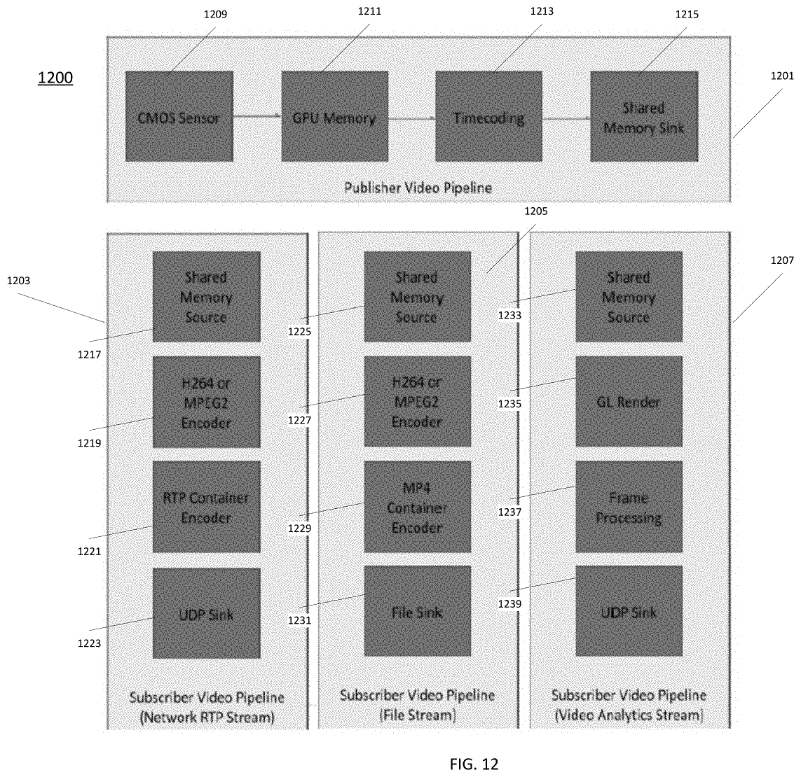

A few example subscriber video pipelines 1200 are shown in FIG. 12. According to a publisher video pipeline 1201, a CMOS sensor 1209, a GPU memory 1211, a timecoding module 1213, and a shared memory sink 1215 are provided. At the subscriber side, the examples include a subscriber video pipeline 1203 via a network RTP stream, a subscriber video pipeline 1205 via a file stream, and a subscriber video pipeline 1207 via a video analytics stream. The subscriber video pipeline 1203 via the network RTP stream includes a shared memory source 1217, an H264 or MPEG2 encoder 1219, an RTP container encoder 1221, and a UDP sink 1223. The subscriber video pipeline 1205 via the file stream includes a shared memory source 1225, an H264 or MPEG2 encoder 1227, an MP4 container encoder 1229, and a file sink 1231. The subscriber video pipeline 1207 via the video analytics stream includes a shared memory source 1233, a GL render module 1235, a frame processing module 1237, and a UDP sink 1239.

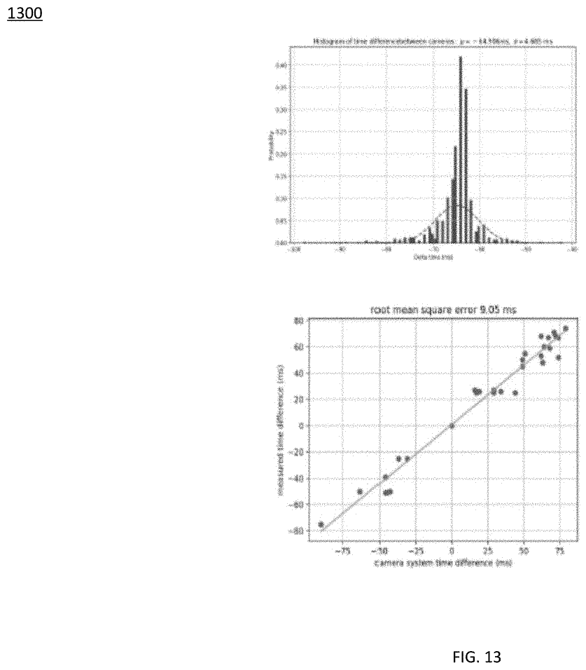

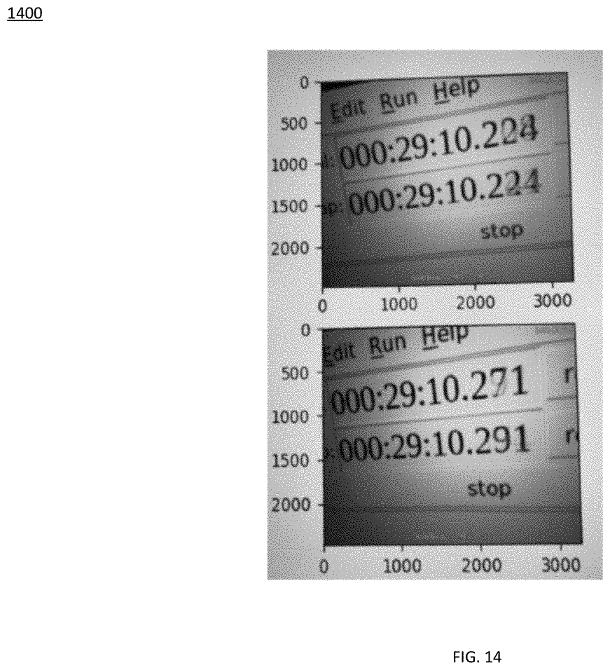

Given that the system time is provided with millisecond precision on a per frame basis, it is possible to measure the difference in time between two camera streams by grabbing the latest frame from the respective shared memory buffer for each camera and comparing the difference in time. This value is ‘delta time estimation’. In parallel, it is possible to derive ‘delta time measured’ by comparing the timestamp on the computer monitor from both cameras. By observing the difference in the millisecond clock from both cameras, ‘delta time measured’ can be derived. An example 1400 is shown in FIG. 14. The monitor and clock rendering frequency introduced a measurement error that can be up to 20 milliseconds Therefore, the refresh frequency at which the millisecond clock updates on the screen affects the precision of the ‘delta time measured’ value. Additionally, the rate at which the monitor refreshes the screen (60 Hz or 120 Hz) also affects the ‘delta time measured’ value. With this in mind, an experiment was performed to compute delta time for hundreds of frames to measure a 64.9 ms mean time difference between frames and a 4.685 ms standard deviation as shown in FIG. 13. A comparison 1300 was performed between the correlation between ‘delta time estimation’ and ‘delta time measured’ as shown in FIG. 13, and the accuracy of the estimation had a root mean square error of 9.05 ms. This means the estimated delta time between two camera pipelines is accurate to 9 milliseconds and below the threshold of 33 ms in a 30FPS video and below the 10 ms threshold in a 100 FPS video stream.

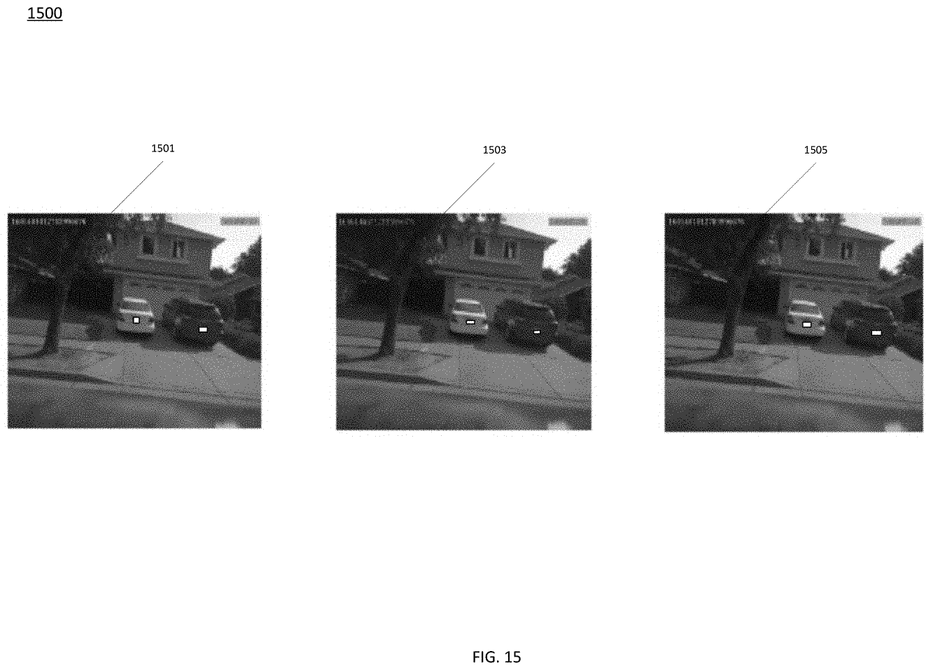

With accurate estimation of the time difference between frame buffers in the two cameras, Depth Aware Frame Interpolation (DAIN) may be used to synthetically generate frames with the exact timestamp to align the video frames from the two cameras. The feasibility of using DAIN from Sony IMX 219 camera frames was test, and realistic video frames generated, that showcase the synthetic interpolated frame buffer at the exact timestamp between the neighboring frames. As shown in FIG. 15, 1501 denotes the prior frame, 1505 denotes the next frame, and 1503 denotes the synthetically generated frame which lies in between the prior and next frame at precisely the ‘delta time estimation’ temporal offset.

From this implementation, this approach is viable for aligning two independent frame buffers from two separate cameras which have a low 21 FPS framerate. This functionality allows cameras to independently synchronize their frame buffers temporally based on a photo realistic synthetically generated image that is derived from a prior and next frame.

### Feasibility Study of Synthetic Frame Upscaling

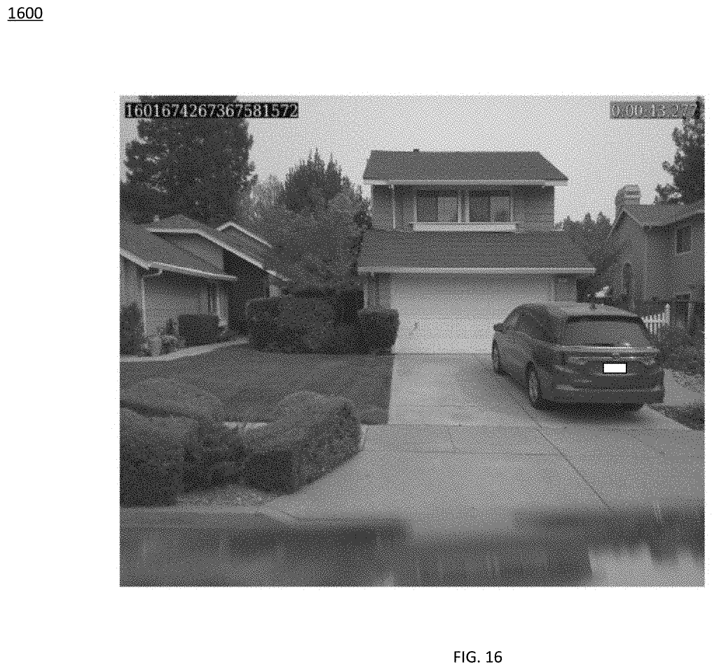

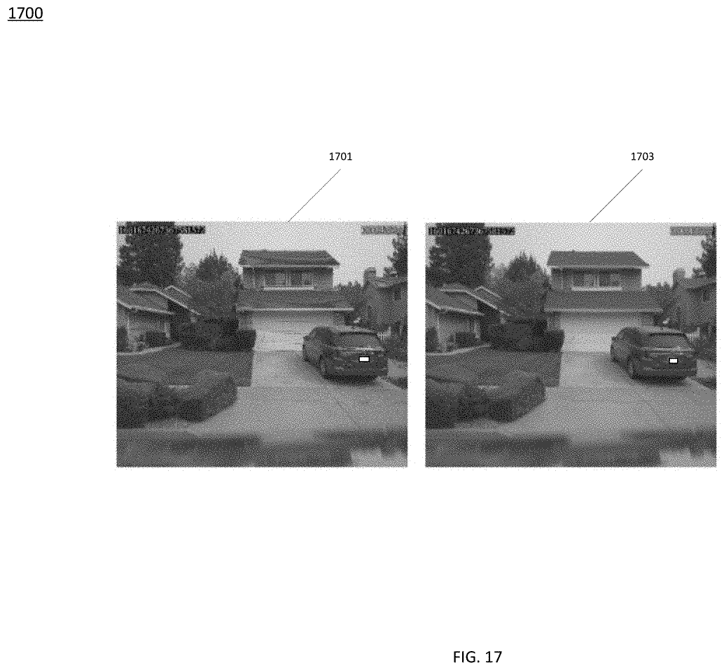

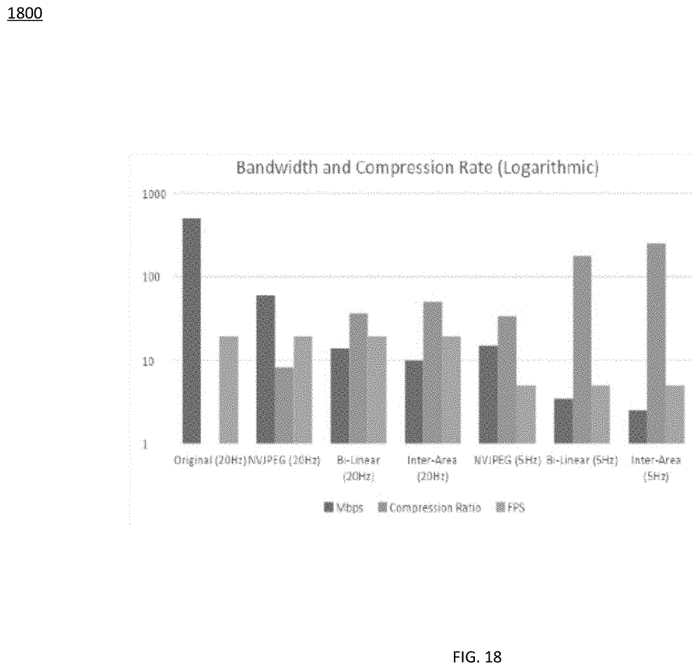

The emergence of Generative Adversarial Networks to upscale images has been rapidly progressing in research labs and there is a tremendous opportunity to commercialize this technology. According to an example implementation, Super Resolution GANs may be used to enhance the image quality in the frame buffer in order to synthetically produce high quality images from a reduced resolution image. This is especially useful in internet-denied environments that have to use low bandwidth directional antennas for communication. Image data can be sent from end point to another by reducing the resolution of the image. A simple experiment below determined the feasibility of the approach. This exercise used an 8 MP Sony IMX camera, which produces 24 megabytes per video frame. The size of the original image was reduced using the NVJPEG encoder on the Xavier NX to a 3 megabytes file as presented in the image 1600 shown in FIG. 16. Additionally, the size of the image was reduced using bi-linear interpolation 1701 and an inter area interpolation 1703 as shown in FIG. 17 using the standard OpenCV modules. The bi-linear interpolation generated a file that was 700 kilobytes in size and the inter area interpolation generated a file that was 500 kilobytes in size. The size comparison is referenced in the chart 1800 of FIG. 18

As seen in the image frames, the bi-linear interpolated image introduced some artifacts that decimate the information in the frame, while the Inter Area interpolated Image seems to have less artifacts and retains a smoother texture. Using this compression pipeline and frame subsampling a 50× compression ratio is achieved compared to the original video pipeline. A spatial compression technique has been executed, but the present implementations are not limited thereto. Additionally, there are more gains if temporal compression is also taken into consideration. With the usage of Depth Aware Frame Interpolation GAN, the 20 Hz video pipeline can be subsampled down to a 5 Hz video pipeline. This further increases the compression ratio to an impressive 250× reduction in bandwidth. Using a combination of spatial (SRGAN) and temporal (DAIN) recovery techniques, it is possible to reduce the amount of information in the original video feed by 250× as shown in FIG. 18.

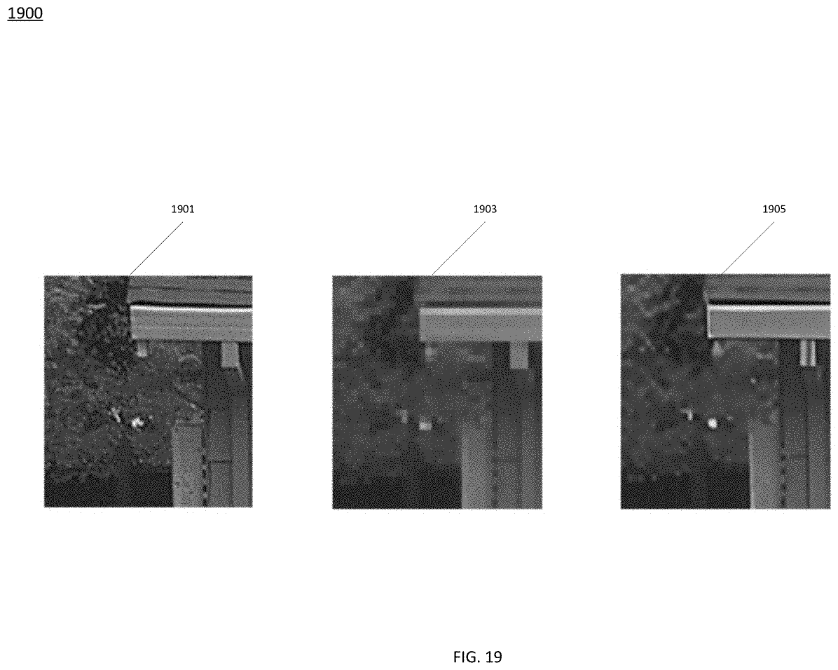

A comparison of the zoomed in image quality of all three images along the same region of interest is shown in 1901 (original), 1903 (reduced Inter-Area interpolation) and 1905 (synthetic SRGAN image), as shown in the images 1900 of FIG. 19.

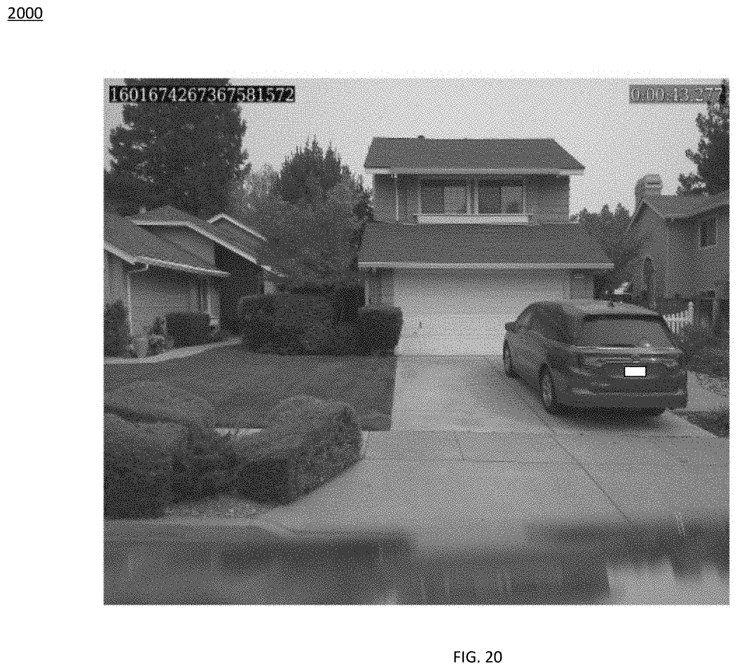

Thus, generative networks are quite powerful because they can infer to fill in the gaps for missing information. The video pipeline can specifically modulate its compression rate and frame sampling rate for each application to make sure all the features of interest are retained. It is possible to recover most of the detail from the original image to the quality shown in the image 2000 of FIG. 20, after reducing the bandwidth by 250×.

### Additional Embodiments

In addition to the foregoing example implementations, hardware prototype PCBs may be provided with accelerated synthetic image processing capabilities for both frame sub sampling, frame resizing and synthetic upscaling/frame interpolation. Additionally, the team will publish a feasibility report on the design, development and production of DAIN and SRGAN hardware accelerated encoders/decoders. The ASIC or FPGA encoders and decoders can then be collocated with cameras and edge computers to dramatically decrease the bandwidth consumption of any video pipeline.

Further exploration of DAIN and SRGAN based video pipelines along with additional codecs being evaluated for video or image inpainting to achieve better image resolution and bandwidth reduction.

Feasibility analysis in using Edge Camera Image inpainting for GDPR compliance utilizing hardware accelerated chips that remove personally identifiable information from video pipelines. The goal would be to put this chip directly adjacent to the CMOS sensor to meet compliance requirements for privacy laws. Example of inpainting would be removal of license plates, blurring faces, and any personally identifiable information.

Finalization of a video pipeline release candidate that can be hardware accelerated to produce dedicated ASIC or FPGA chips that can accelerate the video pipeline.

Addition of hardware design and specifications to open source repository to enable a wider commercial impact under a license. Maturing and deploying the technology to market can be accelerated by using an open source medium for software and hardware distribution.

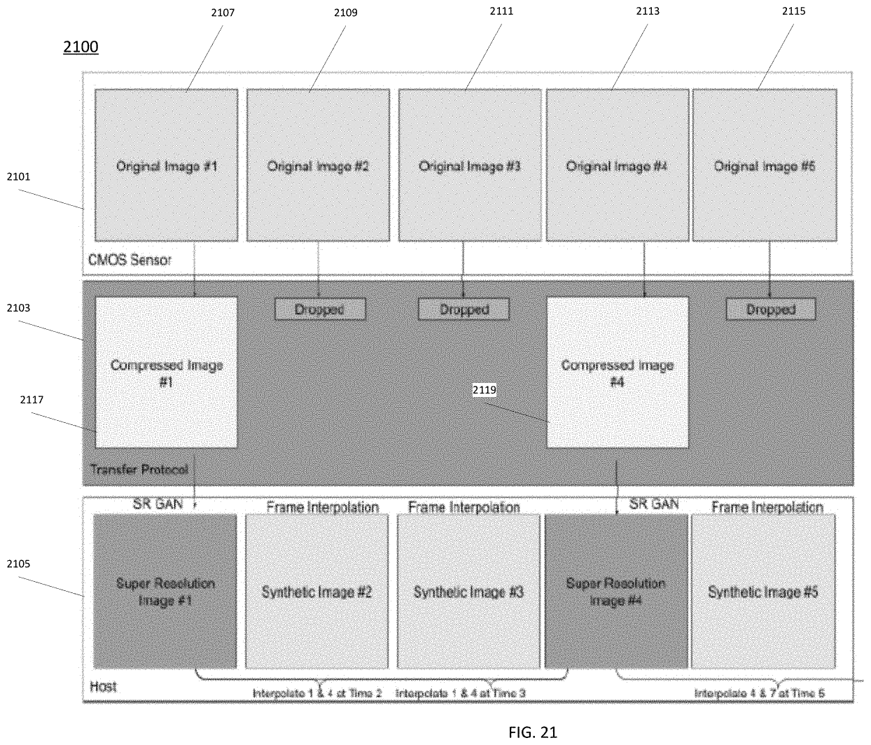

FIG. 21 shows a schematic view 2100 of the example implementations. More specifically, a CMOS sensor 2101 may sense original images, 2107, 2109, 2111, 2113, 2115, and provide these original images to a host 2105 via a transfer protocol 2103. At the transfer protocol 2103, the first original image 2107 and the fourth original image 2113 are compressed at 2117 and 2119, and provided to a host 2105, as the super image resolutions via the SR GAN. As explained above, frame interpolation is performed to interpolate synthetic image #2, #3 and #5. More specifically, super resolution image 1 and 4 are interpolated at time 2 to generate synthetic image 2, and at time 3 to generate synthetic image 3. Super resolution image 4 and a next super resolution image (e.g., 7) 4 are interpolated at time 5 to generate synthetic image 5.

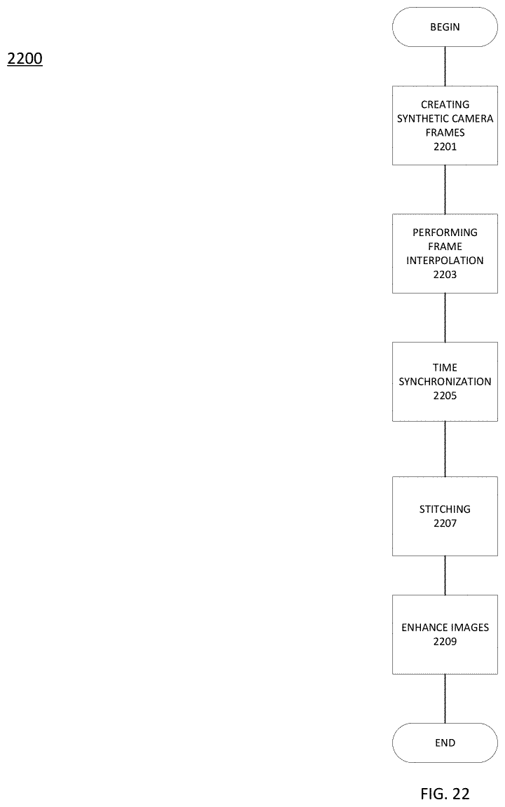

As shown in FIG. 22, aspects may include a method 2200 of augmenting camera devices with neural networks to control framerate, time synchronization, image stitching and resolution. The method 2200 includes creating synthetic camera frames by using neural networks to interpolate between actual frame captures at 2201; utilizing frame interpolation to align camera images when the frames are misaligned in time, with additional hardware at 2203; retroactively processing recorded sensor data to achieve time synchronization from multiple camera sensors at 2205; stitching temporally misaligned camera recordings together to create spherical or panoramic images with vision pipelines augmented by neural networks at 2207; and enhance images by utilizing neural networks to adjust optimize resolution at 2209.

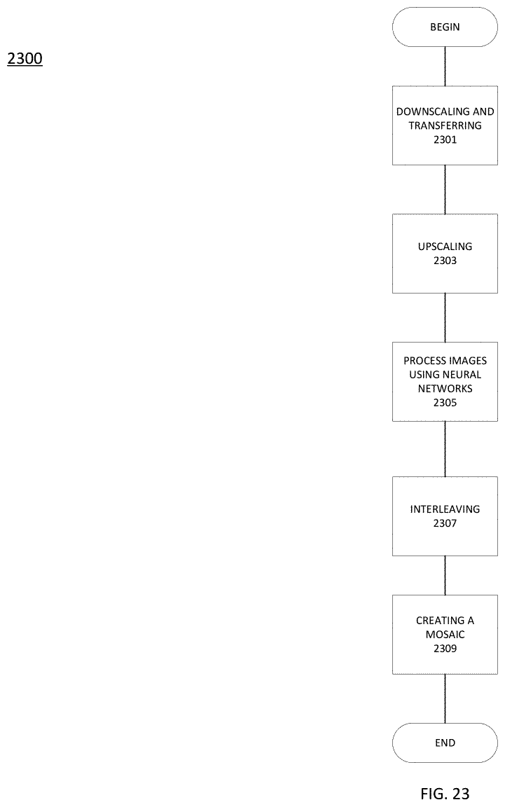

As shown in FIG. 23, further aspects may include a method 2300 to transfer image data on bandwidth constrained communication channels. The method 2300 includes downscaling images and transferring the downscaled images over a communication channel using neural networks at 2301; upscaling using generative networks to restore the original image from a downscaled image at 2303; utilizing hardware encoders and decoders to process images using neural networks at 2305; interleaving large images with small images and using neural networks to upscale the smaller images to match the resolution of larger images at 2307; and creating a mosaic of images by finding overlapping sections of imagery and sampling pixels from multiple images to achieve a higher resolution using neural networks at 2309.

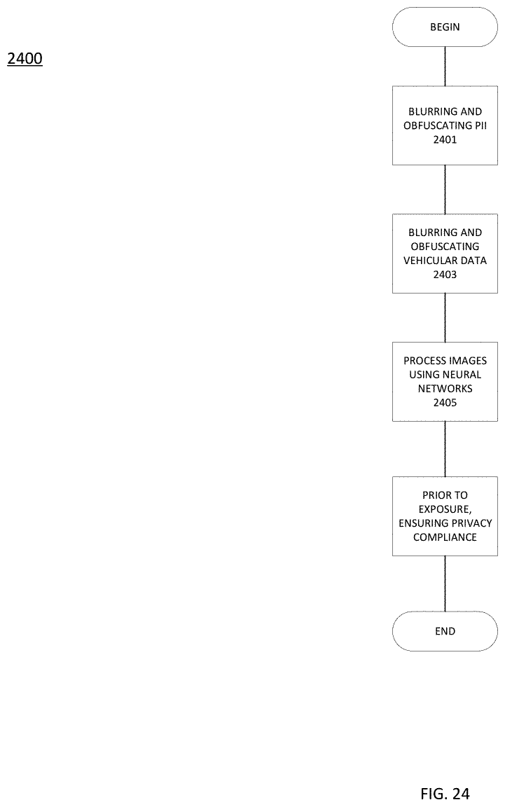

As shown in FIG. 24, still further aspects may include a method 2400 of removing personally identifiable information from camera video feed using hardware accelerated neural networks. The method 2400 includes blurring and obfuscating personally identifiable information including faces, gait, and unique signatures at 2401; blurring and obfuscating vehicular data including license plates, VIN numbers and personnel driving or operating vehicles within camera data at 2403; and before exposing the image data to a computing device, ensuring privacy compliance at a sensor level instead of an application layer at 2405.

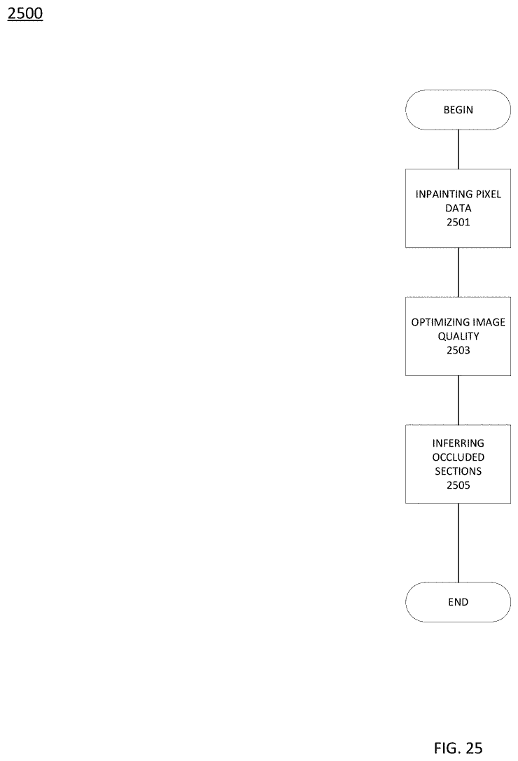

As shown in FIG. 25, yet further aspects may include a method 2500 of improving or denoising camera data using hardware accelerated neural networks. The method includes inpainting pixel data using neural networks to remove artifacts including rain, dust, glare, and adverse effects at 2501; optimizing image quality in low light conditions by using neural networks to optimize the contrast and clarity within images at 2503; and inferring sections of the image which are occluded by objects using generative networks at 2505.

### Feature Parameters May Improve

The main technical parameters which the example implementation may improve include dealing with certain application specific requirements like latency, implications on recall rates for machine learning or computer vision algorithms as a function of synthetic data introduced, and achieving an acceptable form factor, power budget and real-time performance.

Latency: Any additional computation introduced typically will increase latency. This can have a negative impact on real time control algorithms if the latency between the sensor data generation and the feedback control loop is too large. A 100 ms-500 ms hard constraint needs to be introduced for acceptable performance. This might be achievable with dedicated hardware encoders and decoders, but potentially not obtainable with CPU or GPU based systems.

Recall rates: Introducing artifacts may negatively impact AI performance for object detection and tracking, unless a training pipeline with forward transformations also incorporates the artifacts on the training dataset. One potential improvement is to become agnostic to various types of noise by introducing forward transformations to the input data to synthetically enhance AI recall rates.

Small form factor: The processing requirements of the data determine the specifications for computing performance. Keeping a tab on the number of computing operations is necessary to enable small form factor implementations of the novel video pipeline described herein.

Power budget: Parallelization of processing the video pipeline might be necessary. Going from a single host video pipeline to a multiple is a possibility if more than one system is required to process the video pipeline data, especially if real time processing and latency tolerance is to be considered.

Real time performance: Designing a system architecture that can fully exploit the capabilities of DAIN and SRGAN whilst enabling real time control loops is important for autonomous systems. A determination will be made if this is only achievable through a dedicated ASIC or FPGA chip. Comprehensive profiling of compute resources through each stage of the pipeline and optimizing the number of operations can enable real-time performance.

### Embodiments

The methodology to augment cameras synthetically using artificial intelligence may be used to speed up frame rates of camera data, increase the resolution of cameras, achieve better time synchronization, more accurate image stitching and removal of noisy artifacts.

Some use cases may include:

devices utilizing camera sensors with encoding and decoding capabilities that leverage artificial intelligence to boost frame rate, resolution, time synchronization, image stitching and removal of noisy artifacts.

devices utilizing a camera's higher frame speed to align frames temporally even if the shutter is activated in temporally misaligned ways

devices utilizing synthetically temporal frame alignment to achieve higher quality image stitching of panorama and spherical images

devices utilizing artificial intelligence to remove noise from the images.

devices utilizing the higher frame rate from the cameras to improve SLAM performance. SLAM algorithms track features on a camera image frame by camera image frame basis. A large temporal gap between camera image frames may negatively impact the ability to track image features on adjacent frames. By introducing a higher frame rate, SLAM algorithms may benefit from a reduced time interval between frames, reducing the spatial offset of consistent features across adjacent camera image frames.

devices utilizing the removal of noisy artifacts from camera image frames to restore visibility when the vehicle is subject to adverse weather conditions such as rain, wind, day/night, snow, dust or other occlusions.

devices utilizing artificial intelligence to downsample and upsample images with or without hardware acceleration. By utilizing super resolution capabilities, an original image may be downsampled, transferred in an encoded format and decoded back into the original resolution using super resolution generative adversarial networks. The ability to downsample and upsample allows us to restore the original image using inferred pixels that are generated from artificial intelligence

devices may consist of but are not limited to automotive vehicles, robotic systems, mobile platforms, space based systems or application specific platforms

### Use Cases

Survey and Mapping may utilize the pipeline according to the example implementations to dramatically increase the quality and frequency of data captured by post processing existing data. Additionally, previous data or information that is not time synchronized may be time aligned. By allowing surveyors to take fewer frame rate images, the system allows higher frame rate synthetic generation. Mapping fleets may reduce expenses by leveraging synthetic data in place of raw image captures, thereby allowing fleets to achieve industrial level surveying capabilities on consumer hardware.

Autonomous Driving (AD) and Advanced Driver Assistance Systems (ADAS) may utilize the AI pipeline according to the example implementations to create a comprehensive 360-degree perspective of the environment. The increased frame rate leads to a lower drift rate in the SLAM algorithms. The high-resolution imagery and depth estimation pipelines may allow for the AD vehicles to utilize existing Aerial imagery as a reference to localize themselves. This eliminates the need to create high-definition maps in all locations. Additionally, acceleration of vision processing using dedicated neural chips allows for decentralization of processing enabling real time perception/spatial reasoning with a very low power budget. Spatial reasoning is the ability to rationalize the context in a spatial environment to make decisions which aren't necessary pre-coded by generated in real time. AD vehicles need spatial reasoning in order to achieve full self-driving. The current vision sensors by themselves are insufficient to establish a good foundation to accomplish the full self-driving goals augmentation from synthetic vision pipelines using neural networks. Additionally, the denoising pipeline would boost reliability in adverse weather conditions. For example, dust, rain, wipers or snow on the windshield affect the vehicles' ability to perceive the scene. Utilizing image inpainting, the AD or ADAS vehicle may utilize the ability to infer spatial information even though it is occluded to continue operations without a disengagement. Creating real time perception/spatial reasoning pipelines using the neural accelerated vision pipeline allows for greater performance with lower power consumption. Automotive functional safety also benefits because of the lower latency. Most ADAS vehicles currently use rolling shutter cameras, using neural networks to remove motion blur from images is also instrumental in improving readability of landmark features in the scene. Objects such as street names will become more visible at a further distance. Situations of dramatic shifts in light exposure due to transitions from outdoors to a tunnel environment or vice versa is a challenging scenario, synthetic vision pipelines utilizing neural networks can circumvent these gaps and provide a more robust input data stream to achieve automotive functional safety.

Military applications may also benefit from synthetic vision pipelines which utilize neural networks. A common use case involves sending mission intelligence or sensor data from one location to another. Sometimes the data being generated is quite large and the medium for transferring the data might be quite slow. This translates into long wait times that might compromise the mission. Synthetic vision pipelines utilizing neural networks can leverage the down sampling and frame rate modulation to transfer at a much lower bandwidth budget while being able to recover most of the information on the receiving end using frame interpolation, super resolution and image denoising.

The invention in this disclosure is meant to be a general-purpose vision pipeline that can support multiple applications. The description above serves as a few examples on how the technology may be utilized to achieve better performance, safety and cost criteria.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

1. A method of augmenting camera devices with neural networks to control framerate, time synchronization, image stitching and resolution, the method comprising:
creating synthetic camera frames by using neural networks to interpolate between actual frame captures;
utilizing frame interpolation to align camera images when the frames are misaligned in time, with additional hardware;
retroactively processing recorded sensor data to achieve time synchronization from multiple camera sensors;
stitching temporally misaligned camera recordings together to create spherical or panoramic images with vision pipelines augmented by neural networks; and
enhance images by utilizing neural networks to adjust optimize resolution.

2. A method to transfer image data on bandwidth constrained communication channels, the method comprising:
downscaling images and transferring the downscaled images over a communication channel using neural networks;
upscaling using generative networks to restore an original image from a downscaled image;
utilizing hardware encoders and decoders to process images using neural networks;
interleaving large images with small images and using neural networks to upscale smaller images to match a resolution of larger images; and
creating a mosaic of images by finding overlapping sections of imagery and sampling pixels from multiple images to achieve a higher resolution using neural networks.

3. A method of removing personally identifiable information from camera video feed using hardware accelerated neural networks, the method comprising:
blurring and obfuscating personally identifiable information including faces, gait, and unique signatures;
blurring and obfuscating vehicular data including license plates, VIN numbers and personnel driving or operating vehicles within camera data; and
before exposing image data to a computing device, ensuring privacy compliance at a sensor level instead of an application layer.

4. A method of improving or denoising camera data using hardware accelerated neural networks, the method comprising:
inpainting pixel data using neural networks to remove artifacts including rain, dust, glare, and adverse effects;
optimizing image quality in low light conditions by using neural networks to optimize contrast and clarity within images; and
inferring sections of the image which are occluded by objects using generative networks.
